(19) United States
(12) Patent Application Publication
(10) Pub. No.: US 2026/0218803 A1
(43) Pub. Date: Jul. 30, 2026

(54) CHECK VALVE WITH BALL STABILIZER

(71) Applicant: Dixon Valve & Coupling Company, LLC, Chestertown, MD (US)

(72) Inventor: Joel Morales, Waukesha, WI (US)

(21) Appl. No.: 19/038,806

(22) Filed: Jan. 28, 2025

(51) Int. Cl. F16K 27/02; F16K 15/04

(52) U.S. Cl. CPC F16K 27/0209; F16K 15/04

(57) ABSTRACT

A Y-ball check valve is provided and includes a Y-shaped pipe body having an inlet, an outlet, and a pipe section having a free end closed by an end cap. A valve seat and valve ball are located within the pipe body such that the ball is pushed into the pipe section toward the end cap when a pressurized flow of fluid flows from the inlet to the outlet and such that the ball engages the valve seat to form a seal to close the check valve when pressurized fluid flow ceases or is in a direction from the outlet toward the inlet. The end cap includes a stabilizer to engage and stabilize the valve ball when the valve ball is pushed into the pipe section toward the end cap by the fluid flow. The end cap may be in the form of an air blow check valve.

### BACKGROUND

The present invention relates to check valves, and more particularly, to Y-ball check valves, air blow check valves, and combinations thereof that provide stabilization of a valve ball within a Y-ball check valve.

A Y-check valve is used in applications in which reverse flow (i.e., fluid flow from valve outlet to valve inlet) through a piping system or line is to be prevented. The flow of fluid in a reverse direction in the piping system may occur when a pump or like is turned off or when there is a backflow of fluid. Preventing reverse fluid flow may be important, for instance, since this may prevent contamination in applications such as foods and water as well as to prevent damage to equipment such as boilers and pumps.

Y-check valves include an internal component, such as a disc or ball, which is responsible for opening and closing fluid flow through the Y-check valve. The valve is designed to open when fluid pressure is higher at the valve inlet compared to the valve outlet and close should the pressure differential be sufficiently reduced or there is backflow through the valve. The Y-check valve may include a seat where the disc or ball rests in sealing engagement while in the valve-closed condition. The seat is mounted between the inside of the body and the valve disc or valve ball to prevent leakage so that the valve can prevent reverse flow.

The Y-check valve may include a spring to aid the valve disc or valve ball to return to the valve-closed condition after a pump or the like is turned off or when a pressure drop at the inlet occurs. The valve spring is designed with a strength directly proportional to the working pressure of the valve so that the valve disc or valve ball can readily be positioned in the valve-open condition.

In use, the Y-check valve permits fluid flow or prevents fluid flow through the valve body based on pressure difference between the valve inlet and valve outlet. A pressure difference is obtained by having a higher pressure at the valve inlet than at the valve outlet. With a positive pressure difference, the fluid generates a force that acts on the valve disc or valve ball to push it up towards the valve bonnet. This enables the fluid to create a free path from valve inlet to valve outlet where it flows through the check valve. With high fluid pressure at the inlet, the valve disc or valve ball remains in the valve-open condition until a pump or the like is stopped or when the fluid pressure at the inlet is reduced. In this instance, the valve spring forces the valve disc or valve ball to a seated valve-closed position. While the valve disc or valve ball remains in the seating valve-closed position, it engages the valve seat and prevents any fluid from flowing backward (i.e., in a direction from valve outlet to valve inlet). As an option, the Y-check valve may not include a spring and may rely on gravity or backflow to force the valve disc or valve ball into sealing engagement with the valve body/seat. The valve body may not have a seat between the inlet and outlet if the disc/valve ball has an elastomer that can create a sufficient seal to avoid media back flow into the process line. The valve must have a seal between the inlet and outlet when utilizing a disc/valve ball made from a hard plastic.

Accordingly, Y-check valves may be used, for instance, in the production of foods and beverages, in fresh water supply systems, in the treatment of wastewater, in oil and gas refineries, in chemicals and petrochemical applications, in pharmaceutical applications, in steam power generating plants, and in firefighting applications. Advantages of Y-check valves include relatively easy inspection, cleaning, and/or repairing without the need to remove a pipe connection, automatic operation based on pressure difference between the valve inlet and valve outlet, leakage-free and low-pressure loss which helps to enhance high pumping efficiency, lubrication-free, maintenance of working pressure while in operation, prevention of reverse fluid flow, capable of use in low or high-temperature applications, fast acting when opening or closing fluid flow, and versatility since the valves may be used in many different applications ranging from corrosive to non-corrosive media dependent on valve elastomer/ball material used for chemical compatibility.

Y-check valve manufacturers produce various types of valves that range in applications between industrial usage such as for use in waste water treatment mentioned above to hygienic usage in food processing, mentioned above. The type of Y-check valve can vary from a spring loaded Y-check valve to a ball operated Y-check valve, among others dependent on the application. These valves can have various connections such as flange ends, threaded ends, butt weld ends, clamp ends, etc. These valves can also be made of various materials such as plastics, brass, stainless steel, among others.

In particular, a Y-ball check valve is a valve in which the closing component used to prevent reverse fluid flow is a valve ball. This type of valve does not rely on a spring but relies on pressure differentials from the inlet and outlet to operate as well as gravity due to the weight of the ball. In general, when the inlet pressure is greater than the outlet pressure, the valve ball moves upward toward the valve bonnet to open flow through the valve. The ball starts moving toward the valve seat when inlet pressure is reduced such that the outlet pressure is greater than the inlet pressure. Gravity will assist the ball in moving the ball towards the valve body inlet to create a seal. The process is repeated when the inlet pressure is greater than the outlet to move the valve ball upward towards the bonnet. The valve ball may be made of various materials dependent on chemical compatibility of the media being processed and valve ball material. As an example, the valve ball of a hygienic Y-ball check valve is typically made of an elastomer or hard plastic.

Another type of check valve is an air blow check valve. The main function of an air blow check valve is to evacuate product from a process line. The air blow check valve may be connected to any insertion within a system such as a tee branch, a y-check valve, or the like. Such a valve, if connected to a Y-check valve or the like, can be connected to a source of pressurized air to clear out or clean a process line. When pressurized air is not applied to the air blow check valve, the valve remains in a normally-closed condition to avoid the media going into the air blow check valve.

### SUMMARY

According to an embodiment, a Y-ball check valve comprising a Y-shaped pipe body having an inlet, an outlet opposite the inlet, and a pipe section having a free end closed by an end cap. The Y-ball check valve also includes a valve seat located within the pipe body between the inlet and the outlet and a valve ball located within the pipe body such that the valve ball, such as one made of a hard material like plastic, is pushed into the pipe section toward the end cap when a pressurized flow of fluid flows through the Y-ball check valve from the inlet to the outlet and such that the valve ball engages the valve seat to form a seal to close the Y-ball check valve when pressurized fluid flow ceases or is in a direction from the outlet toward the inlet. The end cap includes a stabilizer to engage and stabilize the valve ball when the valve ball is pushed into the pipe section toward the end cap when a pressurized flow of fluid flows through the Y-ball check valve from the inlet to the outlet.

According to another embodiment, an air blow check valve is provided that may be used as the end cap described above. The air blow check valve has a hollow body having a proximal end for being connected to a supply of pressurized gas, a distal end, and a sealing surface located between the proximal and distal ends. A stem and plug is located in the hollow body such that the plug engages the sealing surface when the check valve is in a closed condition. A spring is located within the hollow body to resiliently urge the stem and plug into the closed condition. The distal end of the hollow body includes a valve ball stabilizing hollow extension that extends beyond the sealing surface to stabilize the hard plastic valve ball when the y-ball check valve is in operation, such that, when the valve ball is pushed into the pipe section toward the end cap when a pressurized flow of fluid flows through the Y-ball check valve from the inlet to the outlet, the ball is stabilized.

### BRIEF DESCRIPTION OF THE DRAWINGS

FIG. 1 is a cross-sectional view of a prior art Y-ball check valve.

FIG. 2 is a cross-sectional view of a Y-ball check valve according to an embodiment.

FIG. 3 is an exploded perspective view of the Y-ball check valve of FIG. 2.

FIG. 4 is an elevational view of an end cap of the Y-ball check valve of FIG. 2.

FIG. 5 is a cross-section view of a conventional air blow check valve connected to a Y-ball check valve.

FIG. 6 is a cut-away perspective view of the air blow check valve and Y-ball check valve shown in FIG. 5.

FIG. 7 is a cross-sectional view of an air blow check valve connected to a Y-ball check valve according to an embodiment.

FIG. 8 is an exploded perspective view of the Y-ball check valve of FIG. 7.

FIG. 9 is a cross-sectional view of the air blow check valve shown in FIG. 7.

FIG. 10 is an exploded perspective view of the air blow check valve of FIG. 9.

FIG. 11 is a cross-sectional view of a ball stabilizing air blow body shown in FIG. 9.

FIG. 12 is a cross-sectional view of an air blow body of the prior art air blow check valve shown in FIG. 5.

### DETAIL DESCRIPTION

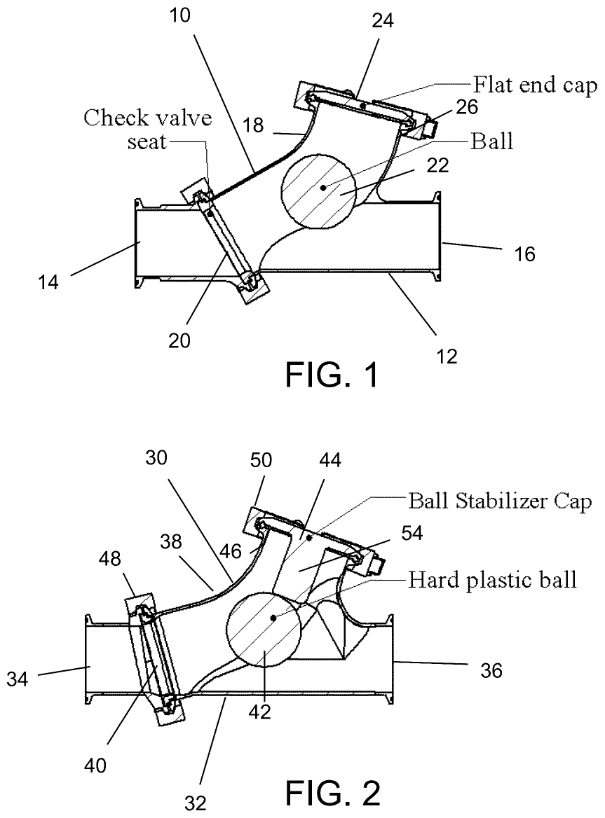

By way of example, a conventional Y-ball check valve 10 is shown in FIG. 1. The conventional Y-ball check valve 10 may have a pipe body 12 with a valve inlet 14, a valve outlet 16 at an opposite end of the pipe body 12, a pipe section 18 providing the valve with a Y-shape and having a free end 26 with a bonnet in the form of a flat end cap 24, a valve seat 20 at a location between the valve inlet 14 and valve outlet 16, and a valve ball 22.

When there is no or limited pressure differential between fluid at the valve inlet 14 and the valve outlet 16 or when fluid flow is in a direction from the valve outlet 16 toward the valve inlet 14 (i.e., backflow), the valve ball 22 is forced into sealing engagement with the valve seat 20 thereby ceasing backflow and closing the Y-ball check valve 10. However, when there is pressurized fluid flow from the valve inlet 14 to the valve outlet 16, the valve ball 22 is forced to move toward the bonnet away from the valve seat 20 thereby permitting flow through the Y-ball check valve 10 in a direction from the valve inlet 14 through the valve seat 20 to the valve outlet 16. In this condition, the valve ball 22 is relatively free to move in an unstable and unsupported condition within the fluid in the pipe section 18 closed by the end cap 24.

Valve ball 22 is made from either an elastomer or from a hard plastic. Hygienic Y-ball check valve bodies are typically made from stainless steel although other non-hygenic Y-ball check valves can be made from other materials such as plastic. If the valve ball 22 is made from a hard plastic, then premature wear of the valve body 12 can occur while the valve ball 22 is at equilibrium with the flow. When in equilibrium, the valve ball 22 will settle between the flat end cap 24 and the valve seat 20. Accordingly, in this condition, the valve ball 22 will rock back and forth in an oscillating motion due to the flow of fluid through the check valve and will cause wear of the walls of the valve body 12, resulting in a leak.

According to an embodiment, a Y-ball check valve, such as a hygienic Y-ball check valve, includes means for stabilizing movement of a valve ball within the body of the check valve to reduce wear. For example, such a Y-ball check valve may include a ball stabilizing end cap as a bonnet that prevents oscillating movement of the hard plastic valve ball and that provides stabilization of the valve ball when in the valve-open open condition such that, when the hard plastic valve ball is in a non-oscillating equilibirum state, no wear can be induced on the body as the valve ball cannot rock back and forth on the Y-ball check valve body.

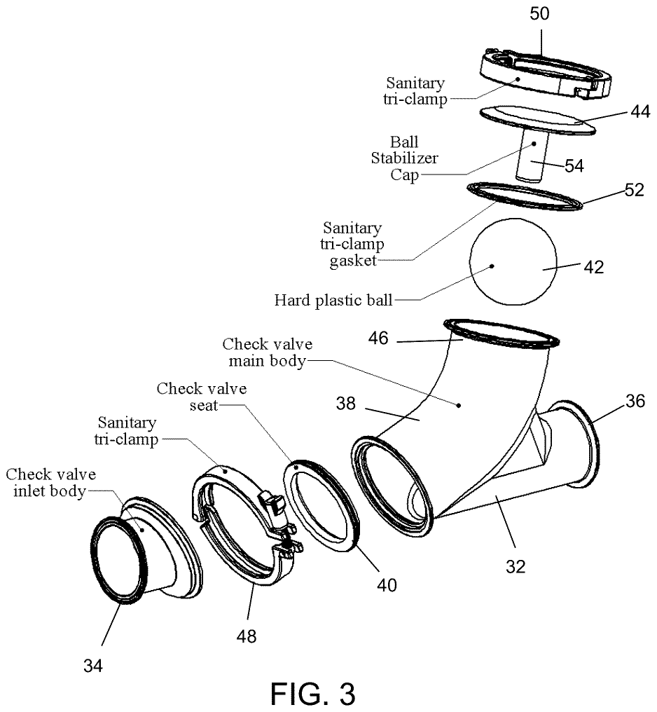

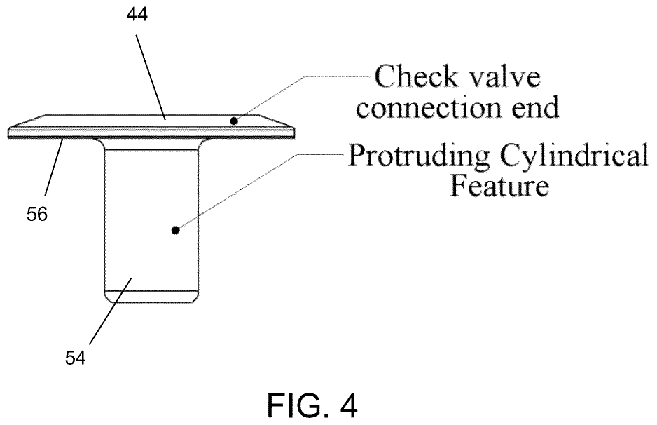

By way of example of such an embodiment, a Y-ball check valve 30 is shown in FIGS. 2-4. As best shown in FIGS. 2 and 3, the Y-ball check valve 30 has some similarities to the Y-ball check valve 10 described above. For example, the Y-ball check valve 30 includes a main body 32 having a valve outlet 36 and a pipe section 38 with a free end 46 closed by a bonnet, a valve seat 40 at an interconnection of the main body 32 and an inlet valve body 34 defining a valve inlet, and a valve ball 42. The bonnet is provided as an end cap 44.

The illustrated embodiment is a hygienic Y-ball check valve and is made of stainless steel; however, it could be made of other materials for non-hygienic application. In addition, a clamp 48, such as a tri-clamp, is used to secure the valve seat 40 sandwiched between the inlet valve body 34 and the main body 32. Further, a clamp 50, such as a tri-clamp, is used to secure the end cap 44 and a gasket 52 to the free end 46 of the pipe section 38.

Unlike the conventional flat end cap 24 as shown in FIG. 1, the end cap 44 of FIGS. 2-4 has a protruding stabilizing component, extension, or stem 54 extending/projecting from a contact side 56 of the end cap 44. The protruding stabilizing component, extension, or stem 54 may be generally cylindrical and concentrically contained within the end cap connection such that it projects and extends into the pipe section 38. The diameter of the cylinder/stem 54 may be less than the diameter of the valve ball 42. The protruding stabilizing component, extension, or stem 54 contacts the valve ball 42 within the pipe section 38 of the main body 32 and the flow from the valve inlet causes the valve ball 42 to engage and rest against the stem 54 preventing the ball from moving back and forth or oscillating and thereby stabilizing the valve ball 42 in the contacted position (i.e., valve-open condition), for instance, as shown in FIG. 2. Otherwise, the check valve 30 acts identical to a traditional hygienic Y-ball check valve with a flat end cap aside from in the valve-open condition

Accordingly, the hygienic Y-ball check valve 30 with ball stabilizer cap 44 utilizes the protruding cylindrical stabilizing component or stem 56 to capture the hard plastic valve ball 42 when the valve is in operation (i.e., open). The protruding cylindrical stabilizing component or stem 56 is concentric with the end cap connection ensuring an easy assembly for the operator and consistent use with every assembly and disassembly as required. With the valve operating with pressurized flow from the valve inlet to the valve outlet, the fluid pushes the valve ball 42 against the protruding cylindrical stabilizing component or stem 54 and prevents the valve ball 42 from rocking back and forth in an oscillating pattern thereby preventing wear from occurring and stabilizing the valve ball 42 within the system or line.

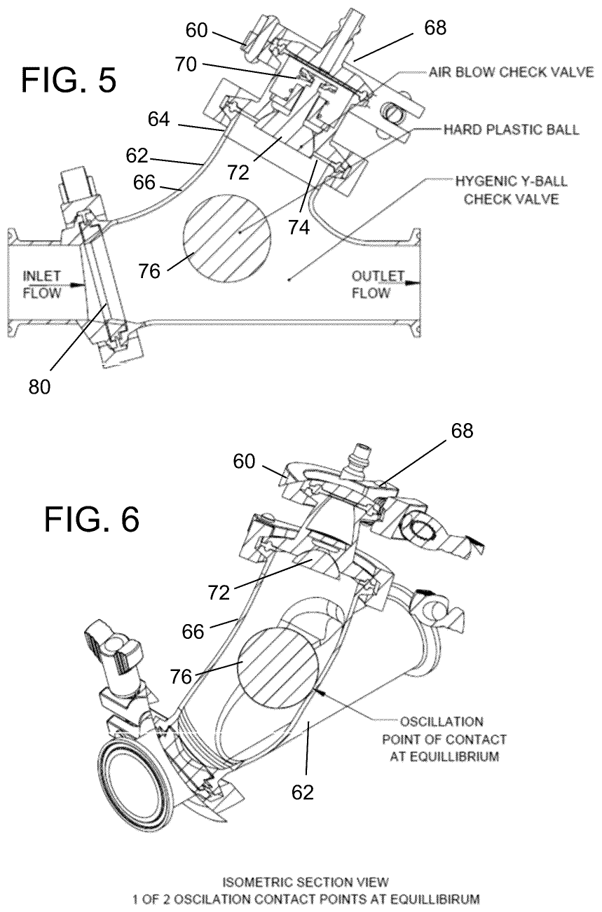

In some arrangements, an air blow check valve may be used in place of the end cap (discussed above) on a Y-ball check valve. For example, the combination of an air blow check valve 60 and a Y-ball check valve 62 is shown in FIGS. 5 and 6. The Y-ball check valve 62 may be the same as Y-ball check valve 30 discussed above, except without the end cap 44. Rather, the free end 64 of the pipe section 66 is connected to an air blow check valve 60 (i.e., the air blow check valve provides a bonnet).

Air blow check valves are generally known for use in evacuating product, cleaning solution, or the like from a process line whether it is attached to a hygienic Y-ball check valve, a tee, or another item in a process line. For example, an air blow check valve may be used to push product/cleaning media through the system or part of a system with the use of pressurized air.

By way of example, a supply of pressurized air (not shown) may be connected to the air tube, or the like, extending externally from a free end 64 of the air blow check valve 60 to open the check valve 60 with pressurized air and to use the flow of air to push product/cleaning media through the piping system or parts thereof. When the pressurized air supply is removed from the check valve 60, a spring 70 within the air blow check valve 60 causes a stem and plug 72 to close the air blow check valve 60.

The product contact side 74 of the air blow check valve 60 acts similar to the flat end cap 24 discussed above relative to FIG. 1, as there is little to negligible intrusion of the air blow check valve 60 into the product line from the stem and plug 72. When such an air blow check valve 60 is used in combination with a hygienic Y-ball check valve as shown in FIGS. 5 and 6, there is no capability for stabilization of the valve ball 76 within the Y-ball check valve 62, as the air blow check valve 60 acts identical to a conventional flat end cap 24, mentioned above, in terms of ball stabilization. FIG. 12 provides an example of the body 78 of a conventional air blow check valve 60.

As stated above, the valve ball 76 can be made from either an elastomer or from a hard plastic, and if the ball is made from a hard plastic, then premature wear can occur on the valve body when the valve ball is at equilibrium with the flow. When in equilibrium, the ball will settle between the air blow check valve 60 and the valve seat 80 of the Y-ball check valve 62. Thus, the valve ball 76 will rock back and forth in an oscillating motion wearing through a wall of the Y-ball check valve 62, resulting in a leak.

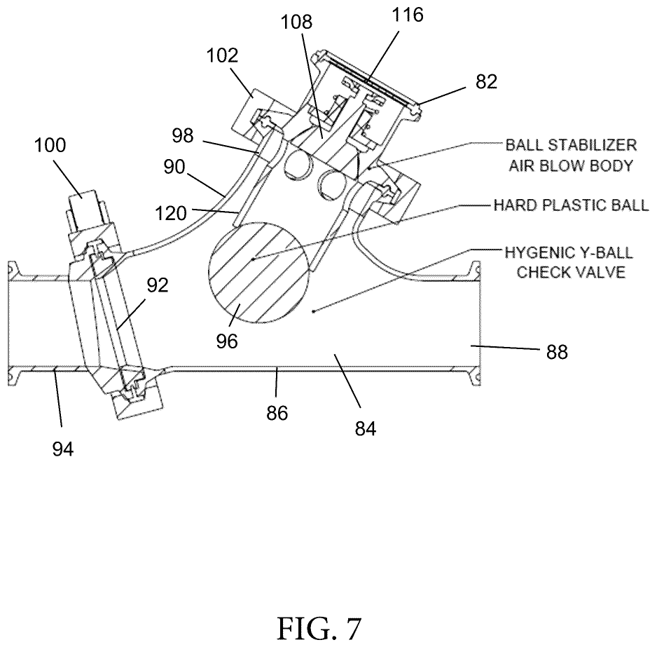

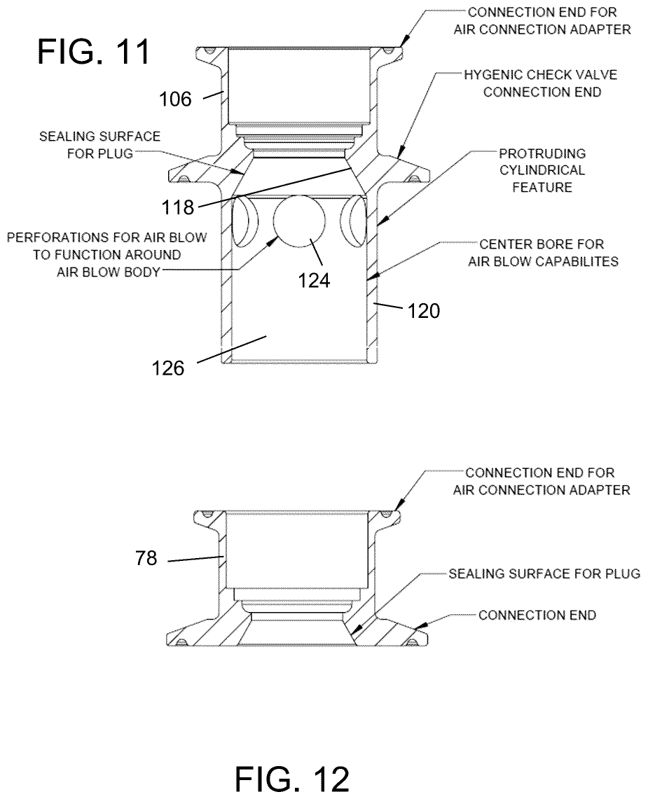

Thus, according to an embodiment, a ball stabilizing air-blow check valve 82 is used as a bonnet for a Y-ball check valve 84 as shown in FIGS. 7-11. The ball stabilizing air blow check valve body acts identical to the ball stabilizer cap 44, mentioned above, in terms of ball stabilization.

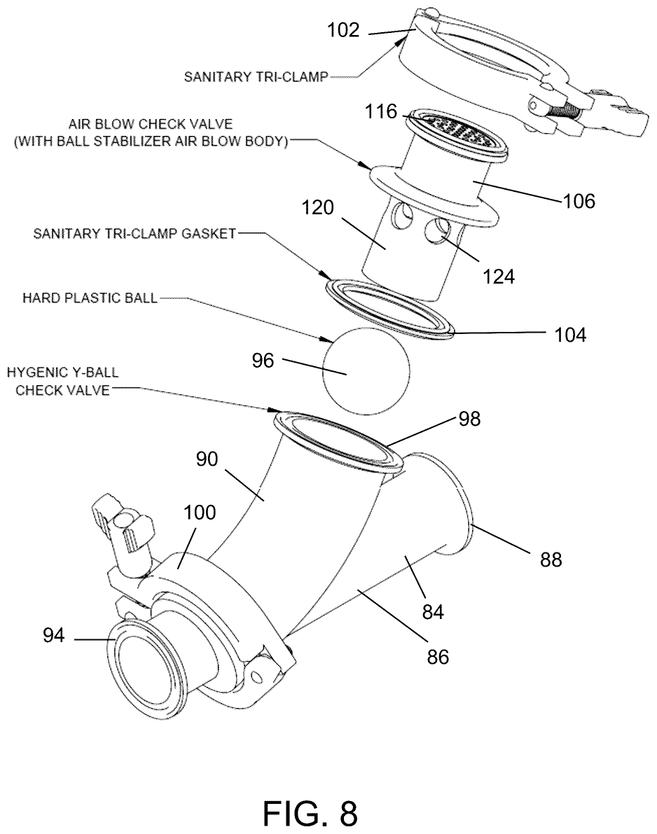

As best shown in FIGS. 7 and 8, the Y-ball check valve 84 includes a main body 86 having a valve outlet 88 and a pipe section 90, a valve seat 92 at an interconnection of the main body 84 and an inlet valve body 94, a valve ball 96, and an air blow check valve 82 connected to the free end 98 of the pipe section 90. The illustrated embodiment is a hygienic Y-ball check valve and is made of stainless steel; however, it could be made of other materials for non-hygienic application. In addition, a clamp 100, such as a tri-clamp, is used to secure the valve seat 92 sandwiched between the inlet valve body 94 and the main body 86. Further, a clamp 102, such as a tri-clamp, is used to secure the air blow check valve 82 and a gasket 104 to the free end 98 of the pipe section 90.

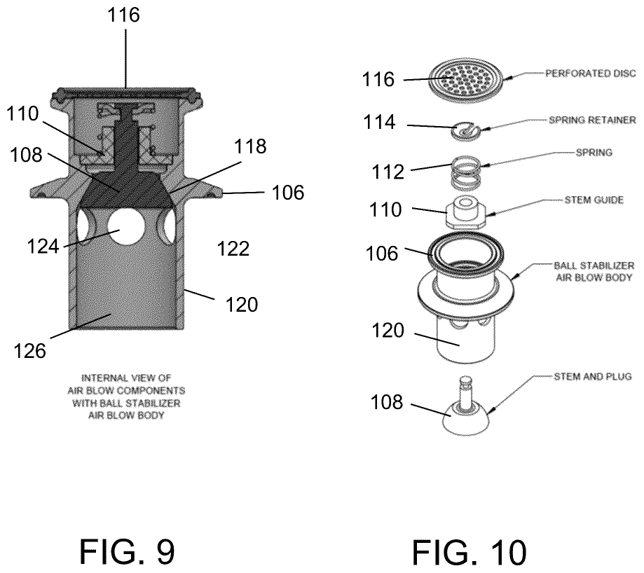

The ball stabilizing air blow check valve 82 is shown in greater detail in FIGS. 9 and 10. It includes a ball stabilizing air blow body 106 in which a stem and plug 108, stem guide 110, spring 112, spring retainer 114, and perforated disc 116 or the like is assembled. As best shown in FIG. 9, the normally-closed condition of the valve 82 is provided by the spring 112 exerting a force on the stem and plug 108 via the spring retainer 114 to pull the plug upward to sealing engage a corresponding wall 118 within the ball stabilizing air blow body 106. The stem and plug 108 only move away from sealing engagement with the corresponding wall 118 within the ball stabilizing air blow body 106 if a supply of pressurized air (not shown) is provided via the perforated disc 116.

The ball stabilizing air-blow check valve 82 prevents oscillating movement of the valve ball 96 by providing stabilization of the valve ball 96 when the Y-ball check valve 84 is in the valve-open condition such that, when the hard plastic valve ball is in a non-oscillating equilibirum state, no wear can be induced on the body as the valve ball cannot rock back and forth on the Y-ball check valve body. The air blow check valve 82 also provides air blow capabilities to evacuate product in the line such as a conventional air blow check valve.

The ball stabilizing air-blow check valve 82 has a protruding generally cylindrical hollow ball stabilizer 120 on a product contact side 122 of the air blow check valve 82. The ball stabilizer 120 is concentrically contained within the end cap connection of the Y-ball check valve 84. The protruding ball stabilizer 120 contacts the valve ball 96 and the flow from the valve inlet of the Y-ball check valve 84 forces the valve ball 96 to rest against the ball stabilizer 120, thereby preventing the valve ball 96 from oscillating motion and stabilizing the valve ball 96 in the contacted position. See FIG. 7.

When the valve ball 96 of the Y-ball check valve 84 is in the closed/seated condition against valve seat 92, the air blow check valve 82 can be connected to a source of pressurized air to evacuate product or cleaning fluid in the line allowing air to enter or exit the Y-ball check valve 82 via the bonnet to push product or cleaning fluid out of the line.

The ball stabilizing air blow body 106 has a series of perforations 124 on the side of the cylindrical ball stabilizer 120 to allow the pressurized air to reach product or cleaning fluid that may reside outside and adjacent the cylindrical ball stabilizer 120. Thus, the ball stabilizer air blow body 106 is made specifically for the hygienic Y-ball check valve 84 as the air blow body 106 provides the protruding cylindrical ball stabilizer 120 to capture the valve ball 96 when the hygienic Y-ball check valve 84 is in operation while allowing for air blow capabilities when the hygienic y-ball check valve 84 is in the closed state. As best shown in FIG. 7, the diameter of the cylindrical hollow ball stabilizer 120 is greater than the stem and plug 108 to allow for interchangeable and identical assembly of the internal components between the conventional air blow check valve body 78 and the ball stabilizing air blow body 106. The internal components, best shown in FIG. 10, are the perforated disc 116, spring retainer 114, spring 112, stem guide 110, and stem and plug 108. The external air connection end cap, not shown, is also interchangeable with the conventional air blow check valve body 78 to allow familiar and easy assembly and disassembly of the air blow check valve 82, as required. The protruding cylindrical ball stabilizer 120 is hollow and concentric with the end cap connection to ensure easy assembly for the operator and to provide a consistent use with every assembly and disassembly, as required.

Thus, with the Y-ball check valve 84 in operation, the fluid pushes the valve ball 96 into the protruding cylindrical ball stabilizer 120 and prevents the valve ball 96 from rocking back and forth in an oscillating motion thereby preventing wear from occurring and stabilizing the ball in the system. The cylindrical ball stabilizer 120 includes a center bore 126 for the air blow to function to evacuate product from the center out. The cylindrical ball stabilizer also includes the perforations 124 near the stem and plug 108 such that when the air blow check valve 82 is in operation, air can go out and around the protruding cylindrical ball stabilizer 120 to evacuate product.

By way of example, and not by way of limitation, the pipe sections of the Y-ball check valve may have an outer diameter with a range of about 1.5 inches to about 4 inches. Of course, the outer diameter of the pipe sections of the Y-ball check valve may be greater or less than the range of size as stated above.

The foregoing description and specific embodiments are merely illustrative of the principles thereof, and various modifications and additions may be made to the apparatus by those skilled in the art, without departing from the spirit and scope of this invention.

1. An end cap for a pipe section of a Y-ball check valve having a valve ball, said end cap including a stabilizer to engage and stabilize the valve ball when the valve ball is pushed into the pipe section toward the end cap when a pressurized flow of fluid flows through the Y-ball check valve from an inlet to an outlet.

2. The end cap according to claim 1, wherein the stabilizer is a projection that extends from the end cap into the pipe section.

3. The end cap according to claim 2, wherein the projection is substantially cylindrical.

4. A Y-ball check valve, comprising:
a Y-shaped pipe body having an inlet, an outlet opposite the inlet, and a pipe section having a free end closed by an end cap;
a valve seat located within the pipe body between the inlet and the outlet; and
a valve ball located within the pipe body such that the valve ball is pushed into the pipe section toward the end cap when a pressurized flow of fluid flows through the Y-ball check valve from the inlet to the outlet and such that the valve ball engages the valve seat to form a seal to close the Y-ball check valve when pressurized fluid flow ceases or is in a direction from the outlet toward the inlet;
wherein the end cap includes a stabilizer to engage and stabilize the valve ball when the valve ball is pushed into the pipe section toward the end cap when a pressurized flow of fluid flows through the Y-ball check valve from the inlet to the outlet.

5. The Y-ball check valve according to claim 4, wherein the stabilizer is a projection that extends from the end cap into the pipe section, and wherein the projection extends concentrically within the pipe section.

6. The Y-ball check valve according to claim 5, wherein the projection is substantially cylindrical.

7. The Y-ball check valve according to claim 6, wherein an outer diameter of the substantially cylindrical projection is less than a diameter of the valve ball.

8. The Y-ball check valve according to claim 1, wherein the end cap is an air blow check valve.

9. The Y-ball check valve according to claim 8, wherein the stabilizer is provided by part of a hollow air blow body of the air blow check valve that extends within the pipe section.

10. The Y-ball check valve according to claim 9, wherein the air blow check valve includes a plug and spring located within the hollow air blow body, and wherein the hollow air blow body provides a sealing surface against which the plug can form a seal in a closed condition of the air blow check valve.

11. The Y-ball check valve according to claim 9, wherein the stabilizer is a hollow extension of the hollow air blow body extending beyond the sealing surface into the pipe section.

12. The Y-ball check valve according to claim 9, wherein the hollow extension of the hollow air blow body extends concentrically within the pipe section.

13. The Y-ball check valve according to claim 12, wherein the hollow extension is a hollow cylinder.

14. The Y-ball check valve according to claim 13, wherein the hollow cylinder includes a series of perforations adjacent the sealing surface.

15. The Y-ball check valve according to claim 4, wherein the valve ball is made of hard plastic.

16. An air blow body of an air blow check valve, comprising:
a hollow body having a proximal end for being connected to a supply of pressurized gas, a distal end, and a sealing surface located between said proximal and distal ends;
wherein the distal end provides a valve ball stabilizing hollow extension that extends beyond the sealing surface.

17. The air blow body according to claim 16, wherein the hollow extension is a hollow cylinder.

18. The air blow body according to claim 17, wherein the hollow cylinder includes a series of perforations adjacent the sealing surface.

19. An air blow check valve, comprising:
an air blow body according to claim 16;
a stem and plug located in the hollow body such that the plug engages the sealing surface when the check valve is in a closed condition; and
a spring located within the hollow body to resiliently urge the stem and plug into the closed condition;
wherein the distal end provides a valve ball stabilizing hollow extension that extends beyond the sealing surface.

20. A Y-ball check valve in which a bonnet of the Y-ball check valve is provided by the air blow check valve according to claim 19 such that the valve ball stabilizing hollow extension extends to a position within the Y-ball check valve to engage and stabilize a valve ball of the Y-ball check valve when the valve ball is pushed into a pipe section toward the bonnet when a pressurized flow of fluid flows through the Y-ball check valve from an inlet to an outlet.
